(19) United States
(12) Patent Application Publication
(10) Pub. No.: US 2010/0194777 A1
(43) Pub. Date: Aug. 5, 2010

(54) IMAGE PROCESSING METHOD AND IMAGE PROCESSING APPARATUS

(75) Inventors: Akira Yamano, Tokyo (JP); Masayuki Nakazawa, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 12/443,963

(22) PCT Filed: Sep. 19, 2007
(86) PCT No.: PCT/JP2007/068144

§ 371 Date: Apr. 1, 2009

(30) Foreign Application Priority Data
Oct. 5, 2006 (JP) 2006-274075

(51) Int. Cl. G09G 5/02; G06T 7/00

(52) U.S. Cl. 345/595; 382/165

(57) ABSTRACT

An image processing method and device for converting monochromatic image data into color display image data, characterized in that the display characteristics are obtained, candidate color display image is selected according to the signal value of the monochromatic image data, at least either target brightness information or target chromatic information at least one of the brightness and chromaticity comprised in the candidate color display image data is calculated based on the display characteristics, the signal value of the color display image data corresponding to the signal value of the monochromatic image data is determined from the candidate color display image data based on at least one of the comparison between each calculated brightness and the target brightness and the comparison between each chromaticity and the target chromaticity, and the signal value of the monochromatic image data is associated with that of the determined color display image data.

### FIELD OF THE INVENTION

The present invention relates to an image processing method and image processing apparatus, particularly to an image processing method and image processing apparatus wherein a color display device displays the monochromatic image having a number of gradations greater than that driven by an image display section.

### DESCRIPTION OF RELATED ART

The diagnostic image captured by a medical diagnostic apparatus such as a diagnostic X-ray apparatus, MRI (Magnetic Resonance Imaging) diagnostic apparatus, and various types of CT (Computer Tomography) scanners is normally recorded on a light transmitting image recording film such as an X-ray film or other photosensitive film material, and is reproduced as a light transmitting image. The film for reproducing this diagnostic image is set on an observation device under the name of a Schaukasten (viewing box) and is observed as it is radiated from the back, whereby the presence or absence of a lesion is detected by diagnosis.

Various types of medical diagnostic and measuring instruments are each connected with a color display such as a CRT (Cathode Ray Tube) display and LCD (Liquid Crystal Display) which serves as a monitor for observing the image obtained by imaging and measurement. The image outputted on such a display screen is utilized to check, adjust, and process the diagnostic image prior to diagnosis or outputting onto the film.

However, when the image captured by the aforementioned diagnostic X-ray apparatus is to be reproduced on a film, a blue-based monochromatic film is often employed in normal cases. Further, the image is often reproduced with a 10-through 12-bit gradation resolution (1024 through 4096) in normal cases.

Accordingly, when an image is diagnosed on a display such as a CRT or LCD, a special-purpose monochromatic display having a gradation resolution of 10 bits or more is often used.

Thus, a color display is used to indicate a color image in an endoscope and retinal camera. In recent years, a color display has come to be employed when a three-dimensional image is displayed on ultrasonic diagnostic equipment, CT apparatuses, and MRI systems.

Overall analysis requires the observation of images from a plurality of types of diagnostic apparatuses. This, in turn, requires the installation of both a special-purpose high-gradation monochromatic display and a color display, with the result that an increase in costs and installation space is unavoidable.

A monochromatic image can be displayed on the color display. However, an image is normally displayed with an 8-bit gradation resolution in the color display. Thus, when an image is to be reproduced on the normal display screen, an image is displayed by the so-called image data of bit dropout wherein the gradation resolution is lower than that of the image captured and outputted in the aforementioned diagnostic X-ray apparatus.

To put it more specifically, when the 10-bit monochromatic image data is to be converted into the 8-bit R, G, and B image data, for example, the 1024-gradation monochromatic image signal value is converted into 258-gradation R, G, and B values based on the LUT (Look-Up Table). In this case, R, G, and B values are equivalent to one another in the conventional LUT, and the R, G, and B image data cannot be subjected to a higher gradation image display in excess of 256 gradations. This problem has been left unsolved in the conventional art.

Further, in the image display apparatus of the invention disclosed in Patent Document 1, the B value is greater than the R and G values in the LUT, whereby the blue-based monochromatic film is reproduced. In this image display apparatus, the LUT is created based on R value=G value=K×B values (wherein 0<K<1). This basically ensures reproduction of the blue-based monochromatic film. However, since the maximum of the R and G values is smaller than 255, the number of gradations that can be displayed is reduced below 256. Thus, when the color tone of blue-based monochromatic film is to be reproduced, a decrease in the number of gradations has raised a more serious problem in the conventional art.

A method of FRC (Flame Rate Control) display has been proposed to display a greater number of gradations than that of the gradations driven by the display.

The FRC display method in the sense in which it is used here refers to the method wherein, the image data of a higher gradation resolution (the greater number of bits) is displayed as the image data of a lower gradation resolution (the smaller number of bits), the image data with the smaller number of bits conforming to the difference in the numbers of bits of the two is generated from the image data of a greater number of bits, and these image data are sequentially displayed, whereby the gradation corresponding to the higher number of bits can be represented by the display of the image with a smaller number of bits.

To put it more specifically, a step is taken to generate the image data of 2ⁿ frames with a smaller number of bits wherein the difference in the number of bits is “n”, and to display these image data with a smaller number of bits sequentially, whereby the gradation corresponding to the 10-bit gradation resolution can be represented by using four frames of the image having an 8-bit gradation resolution, for example.

As in the invention disclosed in Patent Document 2, the images of 766 gradations can be displayed by creating the LUT in such a way that the R, G, and B values are monotone-non-decreasing and the total of the R, G, and B values undergoes a one-by-one change, in addition to the R, G, and B values being equivalent to one another, as shown in the Table 1 of Patent Document 2.

Further, the invention disclosed in Patent Document 3 provides an image display apparatus wherein multicontrast representation is given by using the LUT wherein the signal value of the sub-pixel is changed within a desired range. This image display method is theoretically capable of displaying images of 4096 gradations or more.

Patent Document 1: Japanese. Unexamined Patent Application Publication No. 2000-330530 (Tokkai)

Patent Document 2: Japanese Unexamined Patent Application Publication No. 2001-034232 (Tokkai)

Patent Document 3: Japanese Unexamined Patent Application Publication No. 2003-050566 (Tokkai)

### DISCLOSURE OP THE INVENTION

### Problems to be Solved by the Invention

In the FRC display, however, the operator's eyes are easily tired by the excessive flicker of an image, and there is a greater increase in the processing load required to switch between the divided display data in the time divided representation.

In the image display apparatus disclosed in Patent Document 2, conversion is performed in such a way that the maximum of the input monochromatic image signal values will be the maximum value of R plus the maximum value of G plus the maximum value of B. Further, the R, G, and B signal values are distributed by an approximately uniform division, and severe restrictions are imposed on the combination of R, G, and B values. Thus, if time division display is not used, only images of 766 gradations can be displayed. This has been insufficient for the plain scanning image diagnosis.

The image display apparatus disclosed in Patent Document 3 assumes a multicontrast representation of the monochromatic monitor. This arrangement results in an excessive range wherein the sub-pixel signal values can be selected. Further, the sub-pixel signal values are selected based on the brightness conditions alone. Thus, display cannot be given in a color tone suitable for diagnosis when the monochromatic image is displayed on the color monitor using the LUT having been created. Further, the image display apparatus described in Patent Document 3 is claimed to be applicable to a color monitor. In this case, however, each of the R, G, and B pixels is required to be further divided into sub-pixels. This results in a complicated configuration.

In view of the prior art problems described above, it is an object of the present invention to provide an image processing method and image processing apparatus wherein a monochromatic image of adequate color tone can be displayed with the number of gradations not being less than four times that of gradations driven by the display, without having to perform division of the R, G, and B pixels into sub-pixels or an FRC display.

### Means for Solving the Problems

To solve the aforementioned problems, the invention described in claim 1 is an image processing method wherein one-channel monochromatic image data of n+m bits (wherein “n” is a positive integer of 8 or more, and “m” is a positive integer of 2 or more) is converted into an n-bit 3 or more channel color display image data group, based on a predetermined association principle; the image processing method comprising:

a display characteristic acquisition process for acquiring the display characteristics of the color display device by measuring the test pattern made up of a combination of the color display data displayed on a color display device;

a candidate selection process for selecting a plurality of the candidate color display image data having different signal values for each of the signal values of the monochromatic image data;

a target information acquisition process for acquiring at least one of the target brightness information and target chromaticity information corresponding to each of the aforementioned monochromatic image data;

a brightness/chromaticity calculation process for calculating at least one of the brightness and chromaticity, based on the display characteristic acquired in the display characteristic acquisition process, for each of the aforementioned candidate color display image data;

a signal value determination process for determining the signal value of the color display image data corresponding to each of the signal values of the monochromatic image data, from the candidate color display image data selected in the candidate selection process, based on at least one of the comparison between the brightness of each of the candidate color display image data calculated in the aforementioned brightness calculation process and the target brightness, and the comparison between the chromaticity of each of the candidate color display image data calculated in the aforementioned chromaticity calculation process and the target chromaticity, and an association setting process for setting the association of the signal value of the monochromatic image data determined in the signal value determining process and the signal value of the color display image data.

According to the invention described in claim 1, a step is taken to calculate at least one of the brightness and chromaticity of the candidate color display image data, based on the measurement results in the display characteristic acquisition process. This arrangement improves the precision in the result of contrast of the target brightness or target chromaticity even when the display characteristics of the color display device have been changed by the chronological deterioration of the color display element or variation in the usage environment. This ensures high precision in conversion from the monochromatic image data to the color display image data. To be more specific, even for a monochromatic image of high observer recognizability, an image of adequate color tone can be displayed on the color display device.

The invention of claim 2 is an image processing method described in claim 1 wherein:

the aforementioned target information acquisition process calculates the target brightness information and target chromaticity information;

the brightness/chromaticity calculation process calculates brightness and chromaticity; and

the signal value determination process determines the signal values of the color display image data corresponding to each of the signal values of the aforementioned monochromatic image data, based on the contract between the brightness and target brightness, and the contrast between the chromaticity and target chromaticity.

According to the invention of claim 2, the brightness and chromaticity of the candidate color display image data are calculated based on the measurement results in the display characteristic acquisition process. This arrangement improves the precision in the contrast results of the target brightness and target chromaticity, even when the display characteristics of the color display device have been changed by chronological deterioration of the color display element and variations in the usage environment.

The invention of claim 3 is an image processing method described in claim 2 wherein the aforementioned signal determining process comprises:

a brightness selection process for selecting a plurality of primary candidate color display image data, based on the contrast between the brightness of each of the candidate color display image data and the target brightness; and

a chromaticity selection process for selecting color display image data, based on the contrast between the chromaticity of each of the primary candidate color display image data and the target chromaticity.

According to the invention of claim 3, a plurality of primary candidate color display image data are first elected, based on the contrast between the brightness and target brightness. After that, based on the contrast between the chromaticity of the primary candidate color display image data and the target chromaticity, the color display image data is selected, namely, the color display image data is determined in two stages from the candidate color display image data. This arrangement eliminates the need for estimating the brightness and chromaticity for all the candidate color display image data, and therefore, reduces the processing time and simplifies the structure.

The invention of claim 4 is an image processing method described in any one of claims 1 through 3, wherein the candidate selection process selects C·2̂n (2̂(m+1)≦C≦2̂(m+4)) as the candidate color display image data from among all the combinations of the color display image data that can be displayed.

According to the invention of claim 4, N (2ⁿ⁺²≦N≦2ⁿ⁺³×2^{n+m}) color display image data are selected as the candidate color display image data. This arrangement eliminates the need for estimating the brightness for all the color display image data. Further, this arrangement reduces the association setting time and simplifies the structure, wherein the number of gradations that can be reproduced is sufficiently ensured.

The invention of claim 5 is an image processing method described in any one of claims 1 through 4, wherein this image processing method includes a color tone selection process for selecting a color tone for image display, and the test pattern displayed in the aforementioned display characteristic acquisition process is displayed based on the color display image data selected in response to the color tone selected in the aforementioned color tone selection process from among the combinations of the previously stored color display image data.

According to the invention of claim 5, a preferred test pattern is displayed in response to the selected color tone. This arrangement reduces the frequency of measuring the color required to acquire the display characteristics of the color display device and the frequency of computation processing required by color measurement, and reduces the processing time required in the signal value determination process. This arrangement also ensures the preferred display characteristics to be acquired in response to the color tone having been selected.

The invention of claim 6 is an image processing method described in any one of claims 1 through 5, wherein the color display image data of the test pattern is such a color display image data that the CIE chromaticity coordinates (x, y) are located within the range enclosed by coordinates (0.2, 0.275), (0.275, 0.225), (0.325, 0.4), and (0.4, 0.35).

According to the invention of claim 6, the color display image data of such chromaticity as to be kept within the range of the monochromatic area is selected as the color display image data for the test pattern. This configuration minimizes the frequency of computation and the processing time and, at the same time, eliminates the risk of selecting color display image data outside the monochromatic range.

The invention described in claim 7 is an image processing apparatus wherein one-channel monochromatic image data of n m bits (wherein “n” is a positive integer of 8 or more, and “m” is a positive integer of 2 or more) is converted into an n-bit 3- or more-channel color display image data group, based on a predetermined association principle; this image processing apparatus includes:

a display characteristic acquisition device for acquiring the display characteristics of the color display device by measuring the test pattern made up of a combination of the color display data displayed on a color display device;

a candidate selection section for selecting a plurality of the candidate color display image data having different signal values for each of the signal values of the monochromatic image data;

a target information acquisition section for acquiring at least one of the target brightness information and target chromaticity information corresponding to each of the aforementioned monochromatic image data;

a brightness/chromaticity calculation section for calculating at least one of the brightness and chromaticity, based on the display characteristics acquired in the display characteristic acquisition section, for each of the aforementioned candidate color display image data;

a signal value determination section for determining the signal value of the color display image data corresponding to each of the signal values of the monochromatic image data, from the candidate color display image data selected in the candidate selection section, based on at least one of the contrasts between the brightness of each of the candidate color display image data calculated in the aforementioned brightness calculation section and the target brightness, and the contrast between the chromaticity of each of the candidate color display image data calculated in the aforementioned chromaticity calculation section and the target brightness, and

an association setting section for setting the association of the signal value of the monochromatic image data determined in the signal value determination section and the signal value of the color display image data.

The invention of claim 8 is an image processing apparatus described in claim 7 wherein:

the aforementioned target information acquisition section calculates the target brightness information and target chromaticity information;

the brightness/chromaticity calculation section calculates brightness and chromaticity; and

the signal value determination section determines the signal values of the color display image data corresponding to each of the signal values of the aforementioned monochromatic image data, based on the contrast between brightness and target brightness, and the contrast between chromaticity and target chromaticity.

The invention of claim 9 is an image processing apparatus described in claim 8 wherein the aforementioned signal determination section includes:

a brightness selection section for selecting a plurality of primary candidate color display image data, based on the contrast between the brightness of each of the candidate color display image data and the target brightness; and

a chromaticity selection section for selecting color display image data, based on the contrast between the chromaticity of each of the primary candidate color display image data and the target chromaticity.

The invention of claim 10 is an image processing apparatus described in any one of claims 7 through 9, wherein the candidate selection section selects C·2̂n (2̂(m+1)≦C≦2̂(m+4)) as the candidate color display image data from among all the combinations of the color display image data that can be displayed.

The invention of claim 11 is an image processing apparatus described in any one of claims 7 through 10 including:

a color tone selection section for selecting a color tone for image display; and

a test pattern holding section for storing a plurality of combinations of the aforementioned color display image data test patterns;

wherein the aforementioned display characteristic acquisition section selects a combination of the color display image data of the test patterns displayed on the display section, from among the combinations of the color display image data stored in the aforementioned test pattern holding section, in response to the color tone selected by the color tone selection section.

The invention of claim 12 is an image processing apparatus described in any one of claims 7 through 11, wherein the color display image data of the test pattern is such color display image data that the CIE chromaticity coordinates (x, y) are located within the range enclosed by coordinates (0.2, 0.275), (0.275, 0.225), (0.325, 0.4), and (0.4, 0.35).

### EFFECTS OF THE INVENTION

The arrangement according to the present invention improves the precision in the contrast results of the target brightness or target chromaticity, even when the display characteristics of the color display device have been changed by chronological deterioration of the color display element and variations in the usage environment. This ensures high-precision conversion from the monochromatic image data to the color display image data. Thus, when a medical image diagnosis is applied to the input of the monochromatic image data with a number of gradations amounting to four times or more, an image characterized by sufficient gradation reproducibility and color tone can be displayed even by using a less costly display device with a small number of drive gradations.

### BRIEF DESCRIPTION OF THE DRAWINGS

FIG. 1 is a front view of an image display apparatus in the first embodiment;

FIG. 2 is a block diagram representing the approximate structure of an image display apparatus in the first embodiment;

FIG. 3 is an explanatory diagram representing the range of candidate colors in the first embodiment;

FIG. 4 is a flow chart representing the conversion rule generation process in the first embodiment;

FIG. 5 is an explanatory diagram representing the screen displayed in the color tone selection process in the first embodiment;

FIG. 6 is a flow chart representing the conversion rule generation process in the first embodiment;

FIG. 7 is an explanatory diagram representing the relationship between the test pattern and display characteristics in the first embodiment;

FIG. 8 is an explanatory diagram showing the generation of the standard display function in the first embodiment;

FIG. 9 is an explanatory diagram showing the generation of the standard display function in the first embodiment;

FIG. 10 is an explanatory diagram showing the generation of the standard display function in the first embodiment;

FIG. 11 is a flow chart representing the R-, G-, and B-value selection process in the first embodiment;

FIG. 12 is an explanatory diagram showing the process of selecting the selection color based on the brightness in the first embodiment;

FIG. 13 is a flow chart representing the image display method in the first embodiment;

FIG. 14 is a flow chart representing the R-, G-, and B-value selection process in the second embodiment;

FIG. 15 is an explanatory diagram showing the process of selection based on chromaticity in the second embodiment;

FIG. 16 is an explanatory diagram showing the process of selection based on chromaticity in the second embodiment;

FIG. 17 is a table representing the target brightness with respect to the internal signal value in the first embodiment;

FIG. 18 is a chart representing the result of measuring the brightness in the first embodiment;

FIG. 19 is a chart representing the result of measuring the chromaticity distribution in the first embodiment;

FIG. 20 is a chart representing the result of measuring the color difference in the first embodiment;

FIG. 21 is a chart representing the result of measuring the chromaticity distribution in the second embodiment; and

FIG. 22 is a chart representing the result of measuring the color difference in the second embodiment.

### DESCRIPTION OF REFERENCE NUMERALS

1. Image display apparatus
2. Liquid crystal panel
3. Liquid crystal drive unit
4. Backlight
5. Measuring means
6. Control section
8. Image generation device
10. Data processing section
13. LUT creation unit
61. LUT storage unit
62. Candidate selection section
63. Target chromaticity determination section
64. Target brightness setting section
65. Chromaticity calculation section
66. Brightness calculation section
67. Signal value determination section
68. Test pattern holding section
X. Input unit

### BEST MODE FOR CARRYING OUT THE INVENTION

### Embodiment 1

Referring to the drawings, the following describes the first embodiment of the image display apparatus 1 serving as an image processing apparatus of the present invention. It should be noted, however, that the present invention is not restricted to the examples in the drawings.

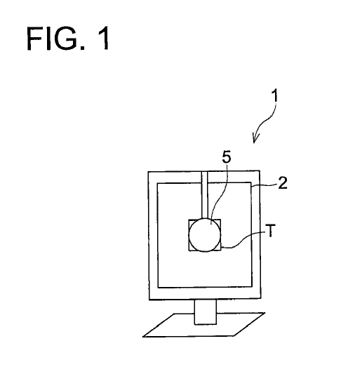

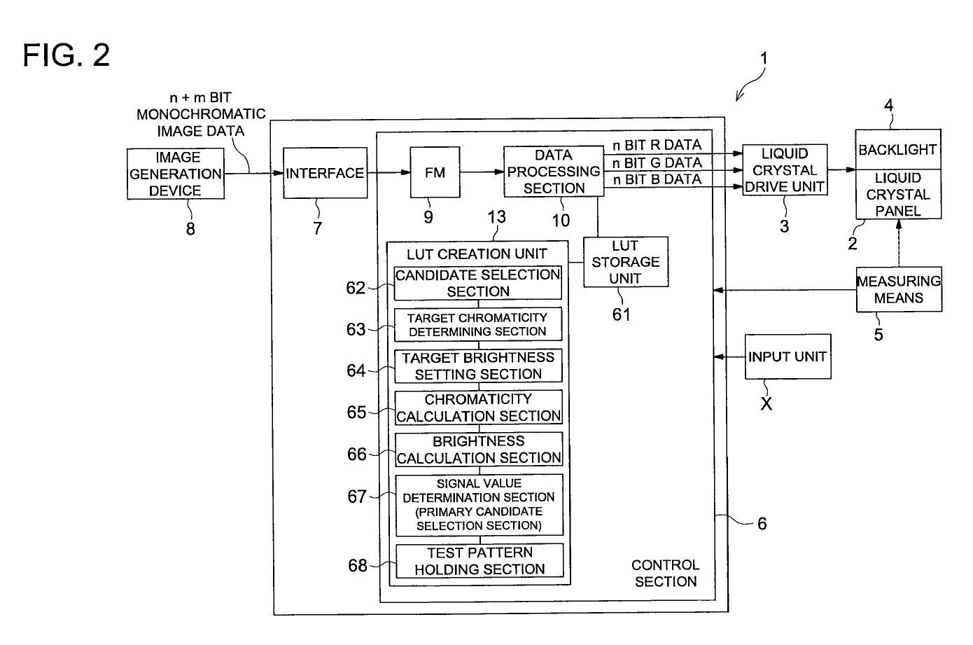

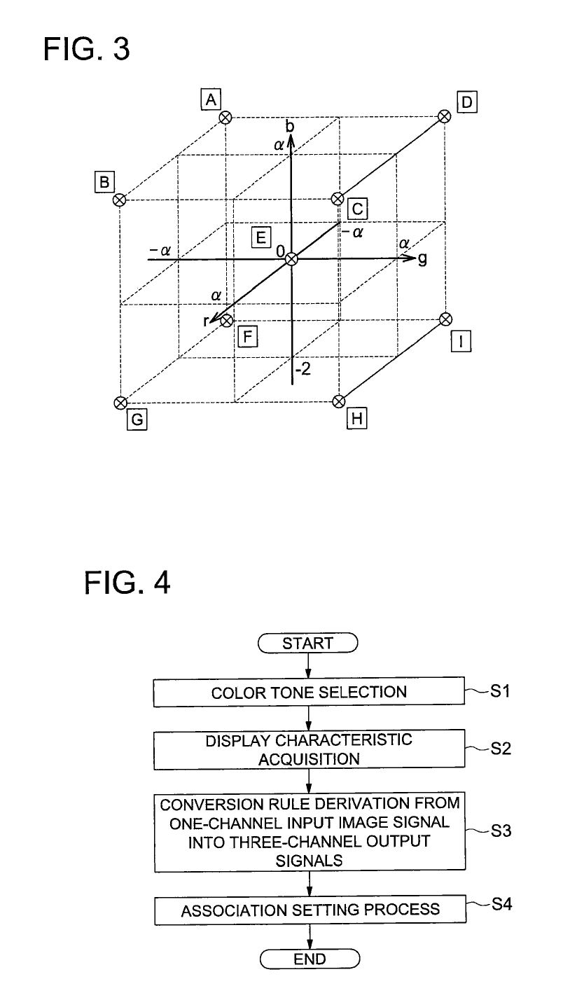

FIG. 1 is a front view of the image display apparatus 1 in the first embodiment. The image display apparatus 1 is exemplified by the monitor of a medical diagnostic apparatus. As shown in FIG. 2, the image display apparatus 1 includes a liquid crystal panel (LCD) 2 and a liquid crystal drive unit 3 serving as a drive section that drives a display section.

There is no particular restriction to the type of the liquid crystal panel 2 applicable to this embodiment. Further, the liquid crystal panel 2 can be driven by the liquid crystal drive unit 3 in various types of methods as exemplified by TN (Twisted Nematic), STN (Super-Twisted Nematic), MVA (Multi-domain Vertical Alignment), and IPS (In-Plane Switching). In the present embodiment, the liquid crystal panel 2 is capable of reproducing gradations of eight bits for each of the R (red), G (green), and B (blue) (a total of 256 steps), using a color filter (not illustrated).

A liquid crystal panel of three colors of R (red), G (green), and B (blue) is employed in the present embodiment. Without the present embodiment being restricted to the three colors of R (red), G (green), and B (blue), it is possible to utilize the three colors of yellow (Y), magenta (M), and cyan (C). It is also possible to use four or more colors—e.g., six colors of R, G, B, Y, M, and C, or six colors of different color tones exemplified by red (R1, R2), green (G1, G2), and blue (B1, B2). Further, the image processing (to be described later) is not restricted to three colors. Without being restricted to the case of a multi-color display using color filters, the present embodiment is also applicable to an image display apparatus capable of multi-color display by switching between the light sources of many colors.

The image display apparatus 1 is provided with a backlight 4 for irradiating the liquid crystal panel 2 with light from the non-observation side. The backlight 4 is only required to supply light capable of illuminating the liquid crystal panel 2. For example, an LED, cold cathode fluorescent tube, cathode fluorescent tube, and other light emitting elements can be employed. The backlight 4 is preferred to display at a maximum brightness of 500 through 5,000 cd/m² in order to ensure preferable application to a monitor for medical use.

The image display apparatus 1 is provided with the measuring means 5 for measuring the display characteristics of the image displayed in a specific target area T of the liquid crystal panel 2. In response to the type of the liquid crystal panel 2, a conventionally known color sensor such as a brightness meter or a chromaticity meter can be used as the measuring means 5.

The illustrated measuring means 5 is a contact-type sensor. A contact-type sensor can also be used as the measuring means 5. There is no particular restriction to the type of a measuring means to be used. Further, the measuring means 5 can be built either inside or outside the image display apparatus 1.

The measuring means 5 is connected to the LUT creating unit 13, and measures the display characteristics which are displayed every time the LUT creating unit 13 switches between the test patterns displayed on the liquid crystal panel 2. The results of the measurements are outputted onto the LUT creating unit 13.

The display characteristics of the liquid crystal panel 2 can be defined as the R, G, and B values inputted into the liquid crystal panel 2, and the information on brightness and/or chromaticity. A commonly employed color system can be used as the information on brightness and/or chromaticity. Examples of the color system include the CIE-stipulated XYZ color system, X₁₀, Y₁₀, and Z₁₀ color system, xyz chromaticity coordinate, x₁₀, y₁₀, and z₁₀ chromaticity coordinate, UCS chromaticity, L*a*b* color system, L*C*h* color system, and L*u*v* color system, without the present embodiment being restricted thereto.

The information on brightness and/or chromaticity can be measured by the measuring means 5 at predetermined time intervals using a test pattern displayed in the target area T of the liquid crystal panel 2. It is also possible to display a test pattern on the liquid crystal panel 2 immediately before shipment from the factory and to store the measurement results. Instead of using the measurement results for each display apparatus, it is also possible to use the arrangement wherein the relationship of correspondence of the information on brightness and/or chromaticity in relation to the R, G, and B values is stored as a predetermined conversion formula.

There is no particular restriction to the position and size of the specific target area T to be used when display characteristics are measured by the measuring means 5. Here the specific target area T is defined as the area corresponding to 10 percent of the central portion of the display screen on the liquid crystal panel 2 in the present embodiment. The measuring means 5 is connected on-line to the image display apparatus 1. For example, it is possible to measure the display characteristics using the measuring means which are not connected on-line to the image display apparatus 1, and to input the measurement results into the image display apparatus 1 through a keyboard input device.

The image display apparatus 1 includes a CPU (Central Processing Unit), ROM (Read Only Memory) for storing various forms of control programs, and RAM (Random Access Memory) for temporary storage of the image data (all not illustrated). It is also provided with a control section 6 for controlling the liquid crystal drive unit 3, an interface (I/F) 7 for connecting between the control section 6 and external equipment, and an input unit X.

The interface 7 is connected with an image generation device 8 as an external device. The image generation device 8 supplies for example, 12-bit monochromatic image data in such a way that the input signal value of the monochromatic image data (hereinafter referred to as “value”) is inputted into the interface 7. There are no restrictions to the type of the image generation device 8. The image generation device 8 is exemplified by an apparatus that takes charge of image processing in various types of medical diagnostic apparatuses such as a diagnostic X-ray apparatus, MRI (Magnetic Resonance Imaging), diagnostic system, and various types of CT (Computer Tomography) apparatuses.

The control section 6 is provided with a frame memory 9 (referred to as “FM” in FIG. 2), data processing section 10, LUT storage unit 61 and LUT creation unit 13. The frame memory 9 stores the monochromatic image data inputted from the image generation device 8 through the interface 7.

The data processing section 10 distributes the n+m bit one-channel monochromatic image data inputted from the frame memory 9, into the three R, G, and B channels, and converts data into the n-bit R, G, and B display image data. In the present embodiment, the data processing section 10 converts the monochromatic image data of n+m (“n” is a positive integer of 8 or more, and “m” is a positive integer of 2 or more) bits into the n-bit R, G, and B display image data, based on a predetermined association determining principle. To put it more specifically, the data processing section 10 distributes the inputted n+m bit monochromatic image data as the internal signal values to the R, G, and B values, based on the LUT storage unit 61 for determining association, and converts them into the n-bit R, G, and B image data. To be more specific, in the present embodiment, the measuring means 5, control section 6, and input unit X serve as the image processing devices of the present invention.

In the present embodiment, the liquid crystal panel 2 provides image display in three R, G, and B colors. Accordingly, the data is converted into the R, G, and B display image data as the color display image data of the three R, G, and B channels. When the display apparatus displays an image in four or more colors, it is only required that the data should be converted into the image data with the number of channels in conformity to the number of colors displayed.

The LUT creation unit 13 includes a candidate selection section 62, target chromaticity determination section 63, target brightness setting section 64, chromaticity calculation section 65, brightness calculation section 66, signal value determination section 67, and test pattern holding section 68. By generating a LUT for association, based on the display characteristics of the liquid crystal panel 2, the LUT creation unit 13 serves the function as the association setting section for setting the association between the signal value of the monochromatic image data and that of the color display image data. The LUT creation unit 13 is connected to the LUT storage unit 61, and ensures that the LUT generated by the LUT creation unit 13 is stored in the LUT storage unit 61. In this case, the LUT creation unit 13 generates the LUT by measuring the display characteristics of the liquid crystal panel 2 (to be described later) at the time of shipment or every passage of a predetermined period of time.

The target chromaticity determination section 63 determines the target chromaticity corresponding to each of the signal values for the monochromatic image data, and the target brightness setting section 64 determines the target brightness corresponding to each of the signal values for the monochromatic image data. In this embodiment, the target chromaticity determination section 63 and target brightness setting section 64 are collectively called the target information acquisition section.

The test pattern holding section 68 stores a plurality of uniform image data (R, G, and B values) to be displayed as the test pattern on the liquid crystal panel 2. There are no restrictions to the number and type of test patterns to be stored. Each test pattern is preferably stored in the form associated with the color tone selection to be described later. This arrangement ensures a preferable test pattern to be displayed in response to the color tone having been selected, and reduces the frequency of measuring the color required to obtain the display characteristics of a color display device, and the frequency of computations involved in color measurement. At the same time, this arrangement cuts down the time required for processing in the signal value determination process, and allows the preferable display characteristics to be acquired in response to the color tone having been selected.

In the present embodiment, the test pattern stored in the test pattern holding section 68 is made up of a combination of color display image data within a predetermined range. To be more specific, for example, the test pattern is made of a combination of the color display image data (R, G, and B display image data within the monochromatic area). Measurement by the measuring means 5 is not applied to the combinations of R, G, and B display image data outside the monochromatic range. The time for acquiring the display characteristics by the measuring means 5 (resulting from the color to be measured and the measurement of colors) can be reduced by restricting the range of measurement by the measuring means 5, as described above. To put it more specifically, the test pattern in the present embodiment includes 256 colors (e.g., value B 10% greater than others) to be added to the 256 colors of R, G, and B values in response to the color tone having been selected, wherein the R, G, and B are not equivalent. To improve the measurement precision, it is also possible to arrange such a configuration that a combination obtained by increasing or decreasing at least one of the R, G, and B values within a predetermined range is displayed as the test pattern, and is measured.

The monochromatic range in the sense in which it has been used so far is the area wherein the chromaticity is enclosed by the coordinates on the CIE chromaticity coordinate system (0.174, 0), (0.4, 0.4), and (α′, 0.4) (wherein α′ refers to the x coordinate at the crossing point between the spectral locus and the straight line whose coordinate in the Y-axis direction is 0.4). However, for the color tone when the image of the blue-based monochromatic image is displayed using the Schaukasten (viewing box), chromaticity has been actually measured at each concentration level on the film for each film and each light source. It has been revealed that the resultant measurements of the chromaticity are concentrated at a considerably limited range. When the chromaticity measurement error and other factors are taken into account, both x and y are preferably assigned with a margin of about +0.01 through 0.02. Thus, in the present embodiment, the monochromatic area is defined as the area enclosed by the coordinates (0.2, 0.275), (0.275, 0.225), (0.325, 0.4), and (0.4, 0.35) on the CIE chromaticity coordinate system.

The LUT creation unit 13 allows the measuring means 5 to measure the color stimulus values X, Y, and Z when the test pattern has been displayed, whereby the measurement results are inputted. In this case, the value Y of the color stimulus values denotes brightness.

The chromaticity calculation section 65 calculates the chromaticity for each of the candidate R, G, and B display image data selected by the candidate selection section 62, while the brightness calculation section 6 calculates the brightness for each of the candidate R, G, and B display image data selected by the candidate selection section 62.

In the present embodiment, the chromaticity calculation section 65 and brightness calculation section 66 are collectively called the brightness/chromaticity calculation section.

The candidate R, G, and B display image data can be selected from among all the combinations of the color display image data that can be displayed when the R, G, and B values are associated with each of the values P. Accordingly, the candidate R, G, and B display image data refers to the color combination data group of the R, G, and B values listed as the candidate colors.

Based on the color stimulus value of the test pattern measured by the measuring means 5, and R, G, and B values, the chromaticity calculation section 65 and brightness calculation section 66 generate an RGB-XYZ estimation formula for approximately estimating the color stimulus values X, Y, and Z when the R, G, and B image data made of a combination of the R, G, and B values yet to be measured is displayed on the liquid crystal panel 2. The RGB-XYZ estimation formula can be expressed by the following formula (1).

$$\begin{matrix}[ Mathematical Formula 1 ] & \\ ( \begin{matrix}( X - X min ) / ( X max - X min ) \\ ( Y - Y min ) / ( Y max - Y min ) \\ ( Z - Z min ) / ( Z max - Z min )\end{matrix} ) = ( \begin{matrix}{C}_{XR} & {C}_{XG} & {X}_{XB} \\ {C}_{YR} & {C}_{YG} & {C}_{YB} \\ {C}_{ZR} & {C}_{ZG} & {C}_{ZB}\end{matrix} ) ( \begin{matrix}{( R / 255 )}^{γ} \\ {( G / 255 )}^{γ} \\ {( B / 255 )}^{γ}\end{matrix} ) & ( 1 )\end{matrix}$$

There are no particular restrictions to the method for generating the formula (1). For example, it is possible to use the least square method to find out the ten unknown variables γ, C_{XR}, C_{XG}, in the formula (1). One of the advantages is that a more accurate RGB-XYZ estimation formula can be generated by increasing the number of test patterns displayed.

Based on the aforementioned formula (1), the chromaticity calculation section 65 and brightness calculation section 66 calculate the information on chromaticity and brightness corresponding to each of the candidate R, G, and B display image data.

The candidate selection section 62 selects C·2̂n (2̂(m+1)≦C≦2̂(m+4)) as the candidate R, G, and B display image data (candidate color), out of the combinations (256³ combinations) of the R, G, and B values serving as 8-bit R, G, and B display image data.

To put it in more detail, the candidate selection section 62 selects the reference color temporarily determined as the target gradation characteristic and the color in the vicinity thereof.

When selecting the color in the vicinity of the temporary target gradation characteristic, the candidate colors are selected within the range obtained by adding the offset values inside ±α of the R, G, and B values (wherein a is a natural number) to each reference color. The candidate colors do not include the R, G, and B data within the range wherein the value cannot be displayed as a result of adding the offset values (wherein the signal value is less than 0, or more than 2ⁿ). When there is an overlap of candidate colors as a result of adding the offset values, the candidate colors to be selected are counted after the overlapped portions have been excluded.

For example, when α=2, the R, G, and B are capable of assuming five numerals from −2 through +2. Accordingly, 125 candidate colors (=5×5×5) can be generated for each reference color. To prevent the adjacent reference colors from overlapping with the candidate colors, the number of offset values is preferably further reduced from 125 colors.

For example, the R, G, and B values of reference color are expressed by the following formula (2).

[Mathematical Formula 2]

R=G=B=k/A (2)

(where all digits to the right of the decimal point are discarded, and k=0 through A, 2²≦A≦2^{m})

The R, G, and B values of reference color are not restricted to equal values. For example, the following formula (3) applies in the case of blue tone.

[Mathematical Formula 3]

B=k/A

(where all digits to the right of the decimal point are discarded, and k=0 through A, 2²≦A≦2^{m})

R=βR·k/A

(where all digits to the right of the decimal point are discarded, and 0<βR<1)

G=βG·k/A (3)

(where all digits to the right of the decimal point are discarded, and 0<βG<1)

The candidate selection section 62 determines the value of a by giving consideration to the balance between the number of the display gradations and chromaticity on the liquid crystal panel 2. In the present embodiment, a can assume any numeral so long as it is a positive integer. To avoid an excessive increase in the numbers N of the candidate colors, α is preferably equal to or less than 3

In the meantime, an α of 4 or more leads to excessive expansion of the range for selecting the candidate color, and prolonged computation time. At the same time, this may result in the selection of color display image data of an undesirable chromaticity.

The candidate selection section 62 determines the reference color when the candidate color is selected in response to the color tone selected by the user preference. For example, the candidate selection section 62 is allowed to store the reference color or candidate color data corresponding to each color tone in advance using formulas (2) or (3).

The candidate selection section 62 selects as the candidate color only the R, G, and B display image data inside the monochromatic area within ±α in relation to the reference color.

In the present embodiment, the monochromatic range is defined as the area enclosed by the coordinates (0.2, 0.275), (0.275, 0.225), (0.325, 0.4), and (0.4, 0.35) on the CIE chromaticity coordinate system, as described above.

The candidate selection section 62 preferably selects only the R, G, and B display image data as the candidate color in such a way that the tri-stimulus value Y of the display color for the R, G, and B display image data and the coordinates (x, y) on the CIE chromaticity chart will meet Δxy≦Δxy0 when the target value on a predetermined chromaticity coordinate is x0 and y0, the color difference is Δxy={(x−x0)²+(y−y0)²}^{1/2}, and a predetermined tolerance is Δxy0.

The candidate selection section 62 determines x0 and y0 as the color coordinates (x, y) in the case that (R, G, B)=(255, 255, 255), and uses the R, G, and B data meeting Δxy≦Δxy0 as a candidate color, assuming that a predetermined tolerance Δxy0 is 0.01.

If it is determined in at least a part of the brightness range that both the target values x0 and y0 will be reduced, the image color tone of the conventional blue-based film can be preferably represented faithfully. To put it more specifically, this can be achieved if βR and βG assume smaller values, as the brightness at the time of display—namely, the target brightness Y for each P value—is smaller in at least a part of the brightness range in formula (3).

The numeral C·2̂n of the candidate color (selected color) selected by the candidate selection section 62 is determined by the trade-off between the reduced computation time and the number required for multicontrast display. Generally, display of a monochromatic image does not require all 16,000,000 colors as candidate colors. Only the computation time will be prolonged.

The candidate selection section 62 can be designed so that, for each of the values P of the monochromatic image data, the candidate color is selected in every candidate selection process (to be described later). It is also possible to use the mechanical selection method of the candidate colors by adding an offset value to the reference value, as described above. Further, it is possible to perform preliminary selection of a candidate color group, which is then stored.

The signal value determination section 67 determines the R, G, and B values of the R, G, and B display image data corresponding to each of the values P of the monochromatic image data. To put it in more detail, the signal value determination section 67 determines one selection color out of the candidate R, G, and B display image data, based on the brightness information from the target brightness setting section 64 and brightness calculation section 66, and sets the R, G, and B values in an associated form as the R, G, and B display image data.

The following describes the image processing method of the present invention.

The details of the LUT generation process to be executed by the LUT creation unit 13 will be described first. The LUT generation process generates or corrects the LUT to ensure that a monochromatic image display of adequate tone color can be achieved in the image display apparatus 1. Processing is started, for example, when the image display apparatus 1 is shipped or the input unit X is operated.

The conversion rule generation process as the associated generation process in this embodiment is implemented in the LUT generation process (FIG. 4). The conversion rule generation process is broadly classified as a process for selecting the color tone of the display image desired by the user (color tone selection process, Step S1), a process for acquiring the display characteristics of the liquid crystal panel 2 (Step 2), a process for deriving the conversion rule (Step S3), and an association setting process (Step S4).

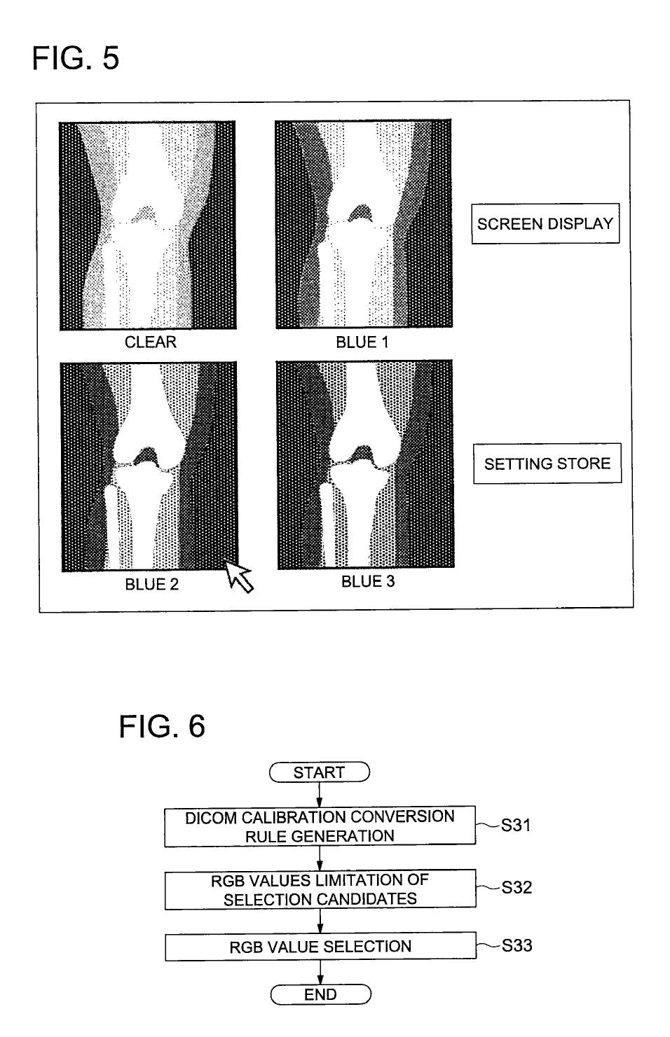

In the color tone selection process (Step 1), for example, a plurality of screens having different color tones as shown in FIG. 5 are displayed on the liquid crystal panel 2, and the display image color tone of the user's preference is selected by the input unit X (FIG. 2) by a mouse or the like. This information is stored. To be more specific, the input unit X serves as the color tone selection section. In FIG. 5, a radiographic image having a total of four color tones—i.e., one neutral gray tone and bluish tones of three different densities—is displayed, and the mouse button is clicked with the pointer placed over the image of the color tone desired by the user, whereby the color tone can be selected. However, there are no particular restrictions to the method of selecting the color tone. Based on the color tone selection results in the color tone selection process, the candidate selection section 62 sets the reference color using the association results determined by the low-gradation association process.

The display characteristic acquisition process (Step S2) acquires the relationship of association of the R, G, and B values inputted through the liquid crystal panel 2 in relation to the information on the brightness and/or chromaticity of the display light. To put it in more detail, in the display characteristic acquisition process (Step S2), the image display apparatus 1 measures the display characteristics of the liquid crystal panel 2 using the LUT creation unit 13. To be more specific, out of the test patterns stored in the test pattern holding section 68, the test pattern previously associated with the color tone selected in Step S1 is selected and displayed on the liquid crystal panel 2 by the LUT creation unit 13. The test pattern displayed on the liquid crystal panel 2 has the tri-stimulus values XYZ of the CIE XYZ display system measured by the measuring means 5. In the present embodiment, as described above, the test patterns stored in the test pattern holding section 68 are composed of a combination of color display image data within a predetermined range (RGB display image data inside the monochromatic area).

The chromaticity calculation section 65 and brightness calculation section 66 generate the RGB-XYZ estimation formula expressed by the aforementioned formula (1), based on the R, G, and B values of the test pattern and the measured tri-stimulus values XYZ. In this case, to generate a more accurate RGB-XYZ estimation formula, the LUT creation unit 13 can be designed in such a way that the color obtained by increasing or decreasing the R, G, and B values of the test pattern within a predetermined range is displayed as a test pattern, and the stimulus values of the liquid crystal panel 2 are measured. There are no particular restrictions to the range of increasing or decreasing the R, G, and B values of the test pattern. To create a more accurate estimation formula, however, this range is preferably determined to agree with the range of the candidate color.

The conversion rule derivation process (Step S3) derives an LUT as a conversion rule for converting the one-channel monochromatic signal value (m+n bits) into the three-channel R, G, and B values (n bits), based on the relationship of association between the information on the brightness and/or chromaticity and the R, G, and B values of the test pattern. In the present embodiment, the LUT is generated as a conversion rule. However, a conversion formula can be used. Further, one conversion formula and LUT may be used. Alternatively, a combination of multi-stage conversion rules can also be used.

In the association setting process (Step S4), the aforementioned conversion rule derived in the conversion rule derivation process (Step S3) is stored in the associated form. To be more specific, in the association setting process (Step S4), the LUT creation unit 13 serves as a setting device.

Referring to FIG. 6, the following describes the details of the conversion rule derivation process (Step S3).

In the present embodiment, the 1-ch intermediate data as the “internal signal value” is defined when the conversion rule is derived. To put it in more detail, (1) the “DICOM Calibration LUT” for association between the P value (1-channel signal value) and internal signal value (1-channel signal value), and (2) the “monochromatic multicontrast LUT” for association between the internal signal value (1-channel signal value) and R, G, and B values (3-channel signal value) are generated. These two LUTs are combined to associate the value with the R, G, and B values.

In the present embodiment, the internal signal value has been determined on the assumption that the number of gradations M of the internal signal value is 2¹² (=4096). To achieve multicontrast representation wherein the number of drive gradations is two or (4 times) or more bits greater than that of the liquid crystal panel 2, the internal signal value should be determined based on at least M=2¹⁰.

Based on the display characteristics of the liquid crystal panel 2, the LUT creation unit 13 generates the DICOM calibration conversion rule for associating the internal signal value with the P value (Step S31). In this case, the DICOM calibration conversion rule is preferably generated as the LUT. Further, the rule is preferably generated in such a way that the display brightness for the P value will conform to the GSDF (Grayscale Standard Display Function) stipulated by the DICOM PS 3.14. The rule can also be generated by using the Standard Display Function according to the conventionally known DICOM Calibration and others.

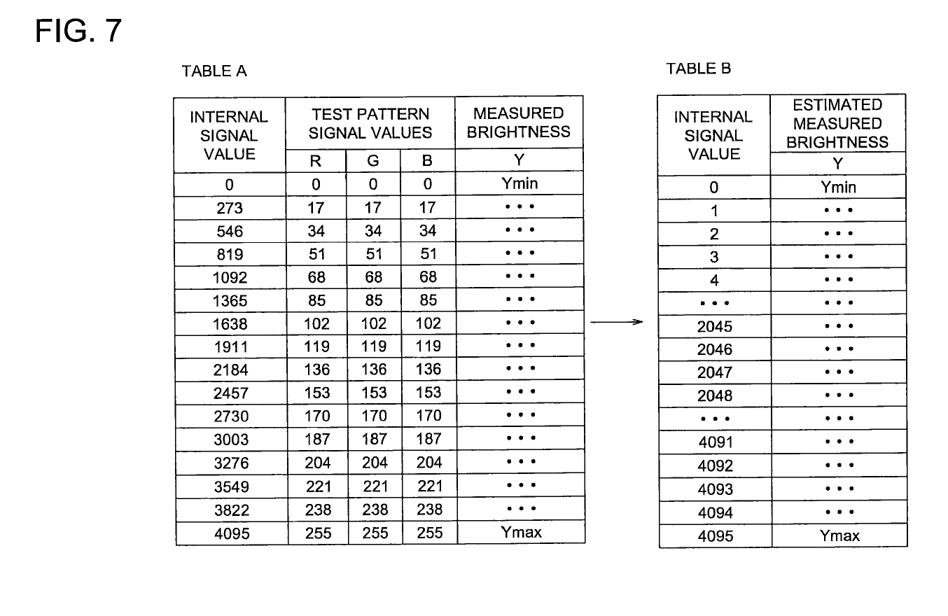

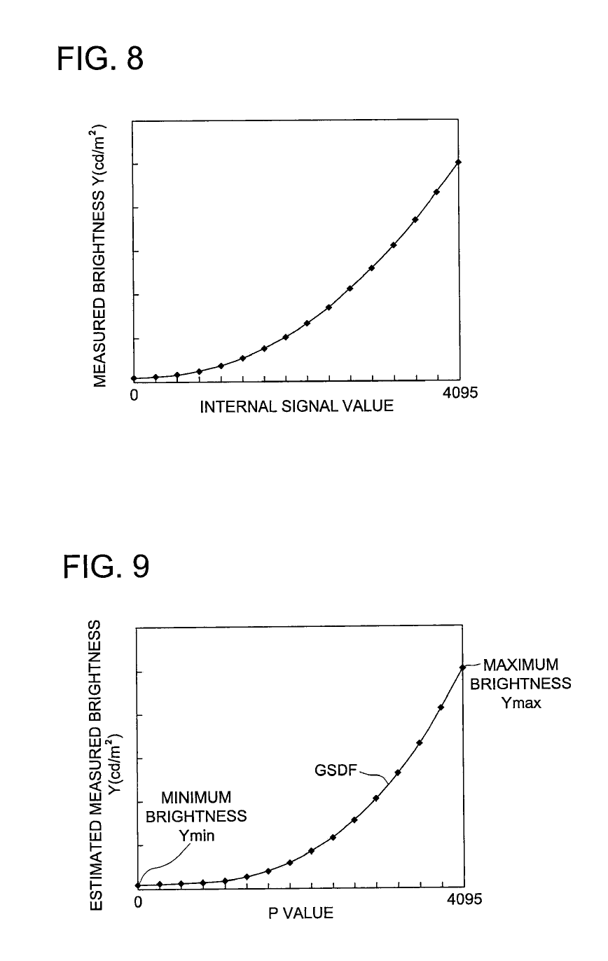

The result of measurement by the measuring means 5 is outputted to the control section 6 and the LUT creation unit 13 associates the R, G, and B values with the brightness of the test pattern. In this case, as shown in Table A of FIG. 7, the LUT creation unit 13 ensures that the internal signals of 16 steps at 273 intervals out of the internal signal values of 4096 gradations (0 through 4095) are assigned with the R, G, and B values of 16 steps at 17 intervals out of the test pattern signal values R, G, and B of 256 gradations, whereby association of the measured brightness in each of the R, G, and B values is achieved. Then the LUT creation unit 13 determines the association between the internal signal values and R, G, and B values according to proportional distribution. In this case, the R, G, and B values need not always be integers. Further, the estimated measured brightness corresponding to each of the R, G, and B values is calculated using the aforementioned formula (1), whereby the estimated measured brightness (Table B and FIG. 8) with respect to the internal signal values of 4096 gradations is estimated. This is followed by the step of the LUT creation unit 13 obtaining the minimum brightness and maximum brightness of the estimated measured brightness. The maximum brightness through minimum brightness is assigned to the P values based on the GSDF (FIG. 9).

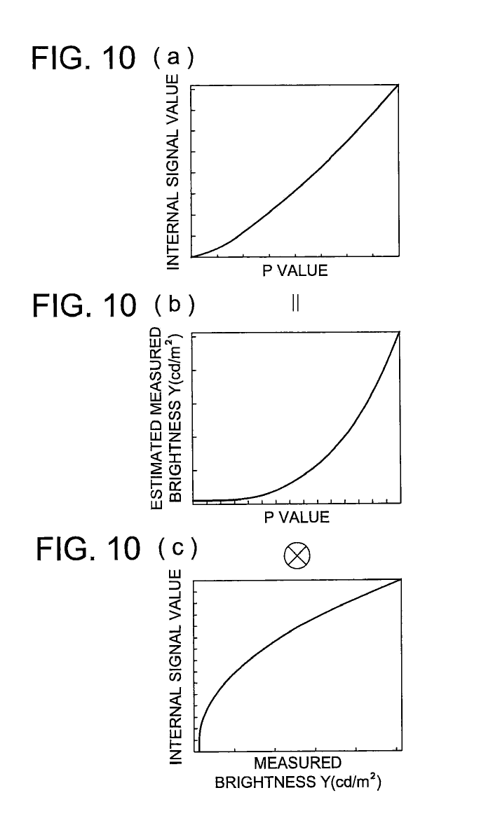

As shown in FIG. 10, a step is taken to generate the calibration LUT for determining the association between the internal signal values and P values. When the image display apparatus 1 has been adjusted to the characteristics of the GSDF curve, the internal signal values and P values are equivalent, and the generated calibration LUT exhibits a proportional straight line of inclination 1. In the meantime, when the image display apparatus 1 has not been adjusted, the calibration LUT exhibits a curve conforming to the characteristics of the liquid crystal panel 2.

In the candidate selection process, for each of the internal signal values of the monochromatic image data, the candidate RGB display image data (candidate colors) of C·2̂n (2̂(m+1)≦C≦2̂(m+4)) are selected out of the R, G, and B display image data containing 256³ signal values by the candidate selection section 62 (Step S32). By limiting the candidate colors to those within the monochromatic area, computation time can be preferably reduced in the subsequent processing, and the possibility of selecting R, G, and B display image data outside the monochromatic area can be preferably eliminated.

In the association determination process, the R, G, and B values are selected from among the candidate colors having been selected, based on the brightness (Step S33). Compatibility between the image color tone and the number of gradations is ensured by the selection of candidate colors based on the brightness in the aforementioned manner.

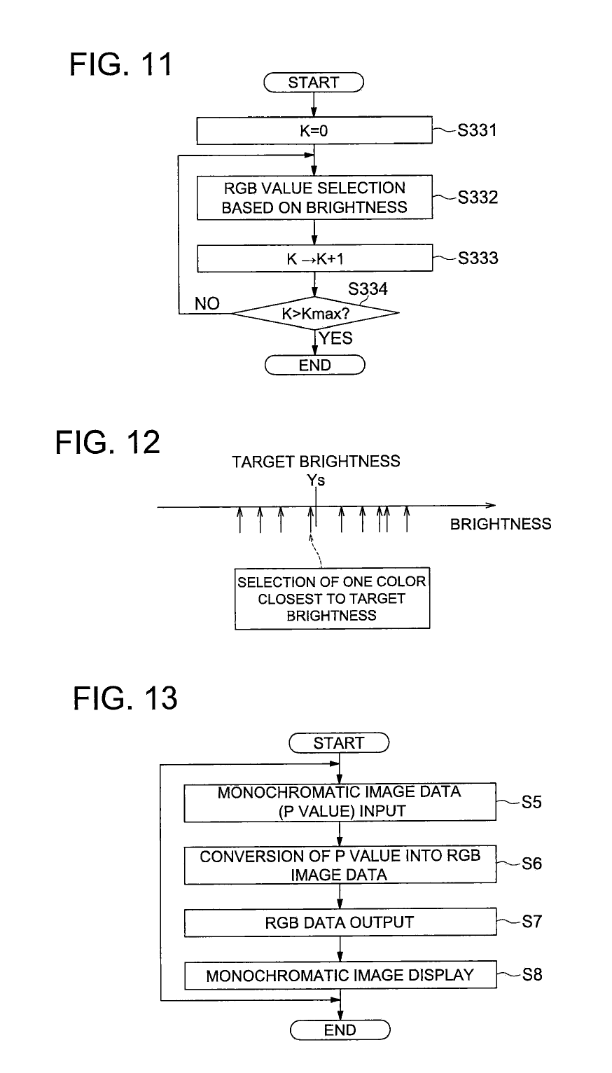

Referring to FIG. 11, the following describes the selection of the R, G, and B values in the association determination process. ΔExy

In the first place, based on the assumption that k=0 (Step S331), the target brightness Y(k) with respect to the internal signal value k is determined by the target brightness setting section 64. The target brightness Y(k) in the sense in which it is used here refers to the brightness of the image that would be represented on the liquid crystal panel 2 when the P value serving as the internal signal value k is inputted into the image display apparatus 1. To put it more specifically, the estimated measured brightness shown in Table B can be used as the target brightness Y(k).

The brightness calculation section 66 uses formula (1) to calculate the brightness Y of each candidate color (brightness calculation process). For example, like as shown in FIG. 12, one candidate color closest to the target brightness Y(k) is selected as the selected color by the signal value determination section 67.

The R, G, and B values of the color selected in the aforementioned manner are formed by the LUT creation unit 13 into the R, G, and B values corresponding to the internal signal value k. Similarly, selection of the R, G, and B values is then carried out (Steps S333 and S334: No) for the internal signal value (k+1), and R, G, and B values are selected for all the internal signal values of 4096 gradations, whereby the LUT generation process terminates (Step S334: Yes).

Referring to FIG. 13, the following describes the method of image processing by the image display apparatus 1.

In the first place, 12-bit monochromatic image data is inputted into the image display apparatus 1 from the image generation device 8 (Step S5). The monochromatic image data having been inputted is inputted into the control section 6 through the interface 7. The monochromatic image data having been inputted into the control section 6 is stored in the frame memory 9.

The monochromatic image data stored in the frame memory 9 is sequentially inputted to the data processing section 10. The data processing section 10 converts the monochromatic image data into the internal signal value of 4096 gradations and distributes the data to the R, G, and B values based on the LUT stored in the LUT storage unit 61 in advance, whereby the data is converted into 8-bit R, G, and B image data (Step S6).

In Step S6, the processing of “DICOM Calibration LUT” is applied to the value P, which is converted into the internal signal value k. This is followed by the step of “monochromatic multicontrast LUT processing” for converting the internal signal value k into the R, G, and B values. In this case, the LUT processing need not be performed in two steps. For example, it is also possible to create a LUT formed by combining the calibration LUT with the conversion LUT for converting the internal signal value to the R, G, and B values, whereby this composite LUT is used to perform one processing.

The R, G, and B image data converted in Step S6 is outputted to the liquid crystal drive unit 3 (Step S7). The liquid crystal drive unit 3 displays the image in conformity to the R, G, and B image data, whereby a 12-bit monochromatic image is represented (Step S8). In the present embodiment, the frame division display mode can be used, as has been described with reference to the cases wherein the frame division display mode is not used. When the frame division display mode is used, the R, G, and B image data converted in Step S6 is divided into four frame data and each of them is stored in a second frame memory (not illustrated). The frame data having been stored is outputted to the liquid crystal drive unit 3 by sequential switching. This procedure allows 12-bit or more monochromatic images to be represented.

In the image display apparatus 1 of the present invention, the LUT is generated or corrected by measuring the characteristics of the liquid crystal panel 2. This arrangement provides a high-precision reproduction of a monochromatic image, independently of fluctuations in the display characteristics of the liquid crystal panel 2.

The image display apparatus 1 of the present invention selects a candidate color within ±α from the reference color wherein the chromaticity is kept within the monochromatic range. This eliminates the possibility of selecting R, G, and B display image data outside the monochromatic range, and allows the brightness to be calculated for such R, G, and B display image data, whereby association is determined. This results in reduced computation time. Further, the selected colors are kept within the monochromatic area. Thus, even when one selected color has been selected by simple algorithmic processing in the association determination process, the selected color can be kept within the monochromatic range.

Without being restricted to the equal values, the R, G, and B values of the candidate color are offset within ±α. This allows the number of alternatives as candidate colors to be increased, and permits multicontrast display in excess of the characteristics of gradation to be given on the display section. Further, this arrangement ensures that an image characterized by high gradation resolution is displayed on the display section.

The RGB-XYZ estimation formula can be used to estimate the brightness and chromaticity. Thus, the target brightness can be estimated from the internal signal value and the chromaticity displayed on the liquid crystal panel 2 can be estimated from the R, G, and B values. The estimation formula is used to calculate the brightness of a plurality of candidate colors, whereby one selection color is selected. This eliminates the need for estimating the brightness of all candidate colors, reduces the LUT correction time, and simplifies the structure.

In the present embodiment, the control section 6 is built in the image display apparatus 1. However, the functions of the control section 6 can be implemented by a personal computer or the like.

In the present embodiment, multicontrast reproduction is possible without the FRC display. It is also possible to arrange such a configuration that multicontrast image display is performed by combination with the FRC display.

### Embodiment 2

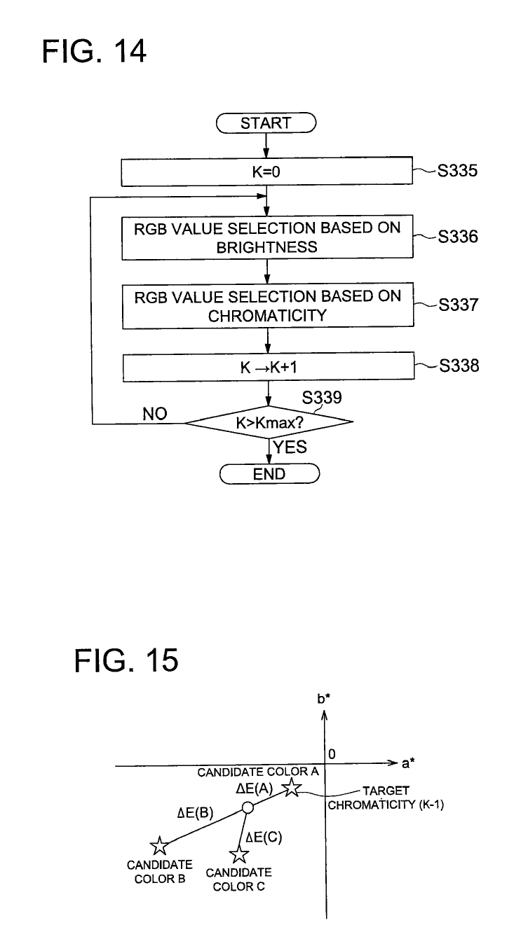

With reference to the flow chart of FIG. 14, the following describes the second embodiment for the selection of R, G, and B values in Step S33 of FIG. 6. As shown in FIG. 14, the present embodiment is different from the first embodiment in that the primary selection based on brightness is followed by the secondary selection based on chromaticity, in the association determining process. The following describes the differences from the first embodiment.

In the present embodiment, the candidate selection section 62 selects C·2̂n (2̂(m+1)≦C≦̂(m+3)) as the candidate R, G, and B display image data (candidate color) from among 256³ combinations of R, G, and B values as the 8-bit R, G, and B display image data.

Further, the candidate colors selected by the candidate selection section 62 are those remaining within the range wherein the offset within ±α of the R, G, and B values of the reference color is added (except for the candidate that will be reduced to 0, or 2ⁿ or more after addition). α can be a positive integer. However, α is preferably 1 or more without exceeding 3 in order to ensure that the number N of the candidate colors will not increase. In order to carry out two-step selection according to the brightness and chromaticity, α can be made greater than that in the first embodiment.

In the image display method of the present embodiment, the target brightness Y(k) with respect to the internal signal value k=0 is determined by the target brightness setting section 64 (Step S335) in the association determination process. After that, the brightness calculation section 66 calculates the brightness Y using the aforementioned formula (1) (brightness calculation process). A plurality of candidate colors A through C closest to the target brightness Y(k) (primary candidate R, G, and B display image data) are primarily selected by the signal value determination section 67. In this case, the number of the primary candidate R, G, and B display image data is 3 in the present embodiment. However, there are no particular restrictions to this number. It can be changed as required.

The chromaticity calculation section 65 calculates the color stimulus values X, Y, and Z using the formula (1) for each of the candidates A through C, and calculates the chromaticity based on the color stimulus values (color calculation process). In this case, chromaticity (L*, a*, b*) pertains to the CIE L*a*b* color system which is generally expressed according to the following formulas (4) through (6) using the color stimulus values X, Y, and Z.

$$\begin{matrix}[ Mathematical Formula 4 ] & \\ L * 116 {( Y / Yo )}^{\frac{1}{3}} - 16 & ( 4 ) \\ [ Mathematical Formula 5 ] & \\ a *= 500 \{ {( X / Xo )}^{\frac{1}{3}} - {( Y / Yo )}^{\frac{1}{3}} \} & ( 5 ) \\ [ Mathematical Formula 6 ] & \\ {b}^{*} = 200 \{ {( Y / Yo )}^{\frac{1}{3}} - {( Z / Zo )}^{\frac{1}{3}} \} & ( 6 )\end{matrix}$$

The chromaticity of the R, G, and B values having been selected with respect to the internal signal value (k−1) of the monochromatic image data is determined as the target chromaticity by the target chromaticity determination section 63 (chromaticity determination process). The signal value determination section 67 calculates the color difference ΔE*ab(k−1) in the CIE L*a*b* color system between the target chromaticity obtained in this manner and the estimated chromaticity of the candidate colors A through C, and selects, on the secondary basis from among the candidate colors A through C, the color wherein |ΔE*ab(k−1)| is minimized (chromaticity selection process in Step S337). For example, as shown in FIG. 12, when the estimated chromaticity of the candidate color A is the closest to the target chromaticity, the candidate color A is the selected color.

The color difference ΔE*ab in the CIE L*a*b* color system is defined by the following formula (7). It can also be defined by the following formula (8) wherein the indicator L* corresponding to the brightness is excluded.

$$\begin{matrix}[ Mathematical Formula 7 ] & \\ Δ E * ab = {\{ {( Δ {L}^{*} )}^{2} + {( Δ {a}^{*} )}^{2} + {( Δ {b}^{*} )}^{2} \}}^{\frac{1}{2}} & ( 7 ) \\ [ Mathematical Formula 8 ] & \\ Δ {E}^{*} ab = {\{ {( Δ {a}^{*} )}^{2} + {( Δ {b}^{*} )}^{2} \}}^{\frac{1}{2}} & ( 8 )\end{matrix}$$

In the chromaticity selection process, the target chromaticity is considered as the chromaticity of the R, G, and B display image data associated with the monochromatic image data of the internal signal value k−1. The R, G, and B display image data of the color wherein the color difference from the target color is the minimum is selected from among the R, G, and B display image data of primary candidates corresponding to the monochromatic image data of the internal signal value k. As described above, the variation in chromaticity can be reduced by selecting the R, G, and B display image data. When the liquid crystal panel 2 is viewed at the normal viewing capacity, the gradation continuity of the chromaticity as a whole can be stabilized.

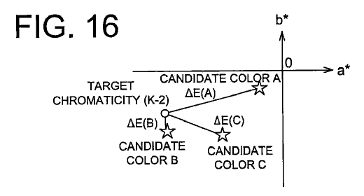

There are no particular restrictions to the number of the target chromaticity levels used in the chromaticity selection process. For example, the target chromaticity corresponding to the monochromatic image data of the signal value k is the chromaticity of the R, G, and B display image data associated with the monochromatic image data of the signal value k−1, and the chromaticity of the R, G, and B display image data associated with the monochromatic image data of the signal value k−2 (FIGS. 15 and 16). It is also possible to arrange such a configuration that |ΔE*ab(k−1)| is defined as the color difference from the chromaticity of the R, G, and B display image data associated with the monochromatic image data of the signal value k−1, out of the R, G, and B display image data of primary candidates corresponding to the monochromatic image data of the signal value k, and |ΔE*ab(k−2)| is defined as the color difference from the chromaticity of the R, G, and B display image data associated with the monochromatic image data of the signal value k−2. Thus, the R, G, and B display image data wherein |ΔE*ab(k−1)|−|ΔE*ab(k−2)| is the maximum that can be selected.

When this algorithm is applied, the candidate color B is selected in FIGS. 15 and 16.

When the R, G, and B display image data is selected in the aforementioned manner, the R, G, and B display image data wherein the variation of the chromaticity in the signal value of the adjacent monochromatic image data is maximized within the range permissible to the user, and the R, G, and B display image data wherein the variation is minimized are selected on an alternate basis. Thus, when the liquid crystal panel 2 is viewed at the normal viewing capacity, the gradation continuity of the chromaticity can be stabilized even in the image wherein the low and high brightness sections are adjacent to each other.

The R, G, and B values of one color selected in this manner is treated as the R, G, and B values corresponding to the internal signal value k by the LUT creation unit 13. This is followed by the step wherein the LUT creation unit 13 selects the R, G, and B values for the internal signal value k+1 in a similar manner (Steps S388 and 339: No). Thus, the R, G, and B values are selected for all the internal signal values of the 4096 gradations. Then the LUT generation process terminates (Step S339: Yes).

As described above, in the image display apparatus 1 of the present embodiment, the colors closest to the desired brightness are selected on a primary basis out of the candidate colors of each internal signal value. Then one selection color is selected based on the chromaticity, whereby the LUT can be generated or corrected. This arrangement permits use of the LUT conforming to the display characteristics of the liquid crystal panel 2. Further, the selection color is selected out of a plurality of candidate colors for the internal signal value. This increases the number of the alternatives made up of combinations of the R, G, and B values on one internal signal value. Thus, the image display apparatus 1 of the present embodiment achieves a multicontrast display in excess of the gradation characteristics of the liquid crystal panel 2, and representation of an image characterized by excellent gradation resolution.

### EXAMPLES

### Example 1

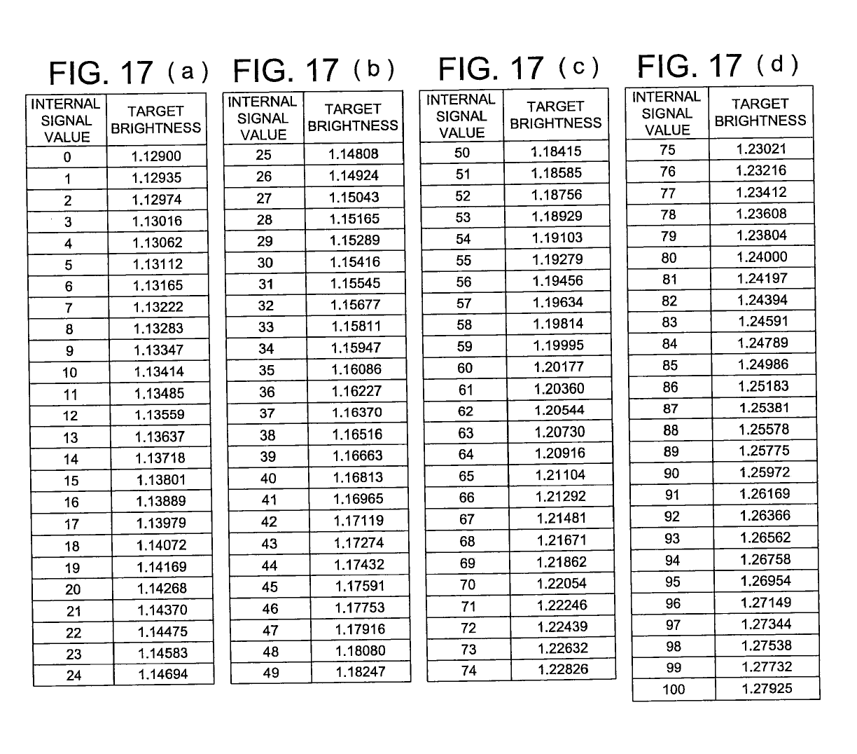

A uniform image corresponding to the input gradations from 0 through 100 was created and the LUT created according to the first embodiment of the present invention was used to perform the conversion. In this case, α=1 was assumed in the candidate selection process. The signal value determination process selected a candidate wherein the calculated target brightness is closest to the target brightness Y(k). FIG. 17 shows the target brightness for the internal signal values 0 through 100 wherein the LUT was created in this embodiment.

In a Comparative Example, the brightness was calculated for all the R, G, and B display image data in the brightness information acquisition process, without the process of candidate selection being used. The candidate closest to the target brightness Y(k) was selected in the signal value determination process. Except for this, the same procedure as that in the Example was used to create an LUT, and the aforementioned uniform image conversion was performed.

After conversion using the LUT was created, the image based on the obtained color display image was displayed on a 3-mega pixel color liquid crystal monitor (FA-2090 by Eizo Nanao Corporation) adjusted to γ=2.2, and the brightness and chromaticity were measured at a viewing angle of 2° using a brightness meter (LS-1000 by Konica Minolta Sensing Co., Ltd.).

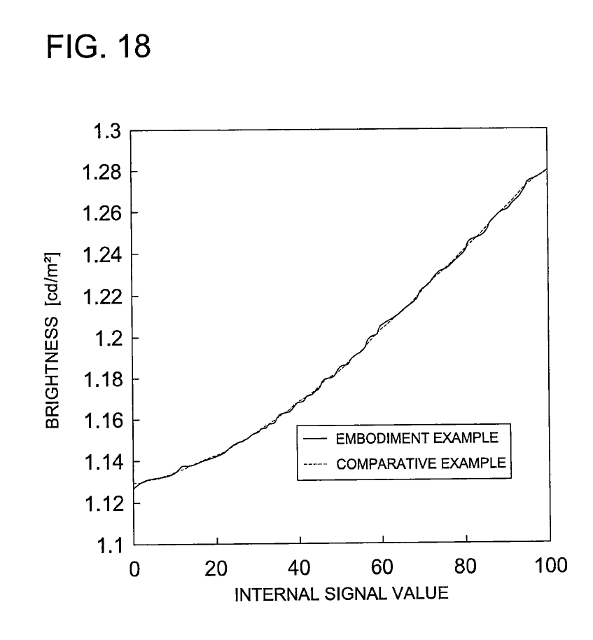

FIG. 18 shows the results of measuring the brightness. The gradation level is plotted on the horizontal axis, while the measured brightness level was plotted on the vertical axis. Approximate agreement was found between the results of the measurement in the Example and the Comparative Example.

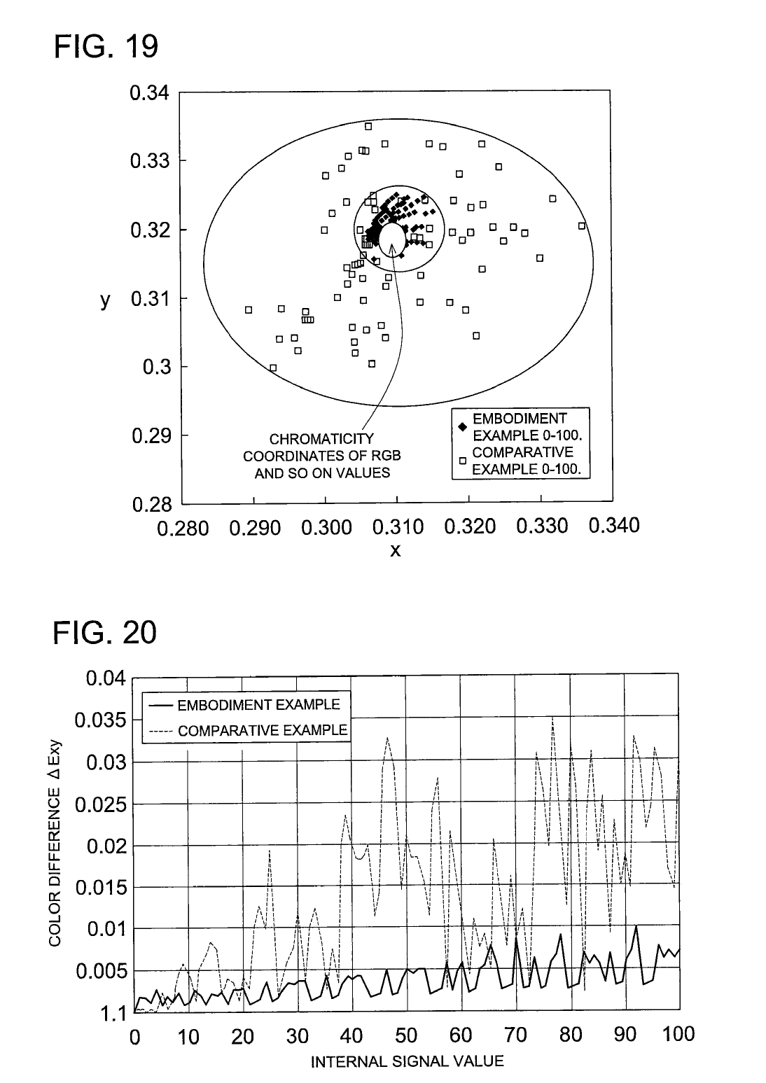

FIG. 19 shows the results of measuring the chromaticity. FIG. 19 is a CIE xy chromaticity chart. The chromaticity with respect to the internal signal value from 0 through 100 exhibits distribution over an extensive range in the Comparative Example. In this Example, however, the chromaticity is located close to the chromaticity of R, G, and B equivalent values and others. This suggests that the chromaticity is located in the adequate range.

In FIG. 20, the internal signal value is plotted on the horizontal axis, and the color difference between the adjacent internal signal values is plotted on the vertical axis. In the Comparative Example, there is a big difference between the adjacent internal signal values. Accordingly, in the image exhibiting a smooth change in brightness, there is a noticeable dispersion of chromaticity for each level of brightness. In this Example, there is a small color difference between the adjacent internal signal values. Thus, the image exhibiting a smooth change in brightness can be displayed without the chromaticity being dispersed.

### Example 2

Conversion was performed using the LUT created in the second embodiment of the present invention. In this case, α=2 was assumed in the candidate selection process. In the primary selection based on brightness in the signal value determining process, three candidates wherein the brightness calculated for each candidate color was closest to the target brightness Y(k) of the internal signal value k were selected as the R, G, and B display image data of primary candidates. A further step was taken to select, out of the three R, G, and B display image data of primary candidates, the data wherein R, G, and B display image data and chromaticity associated with the monochromatic image data of the internal signal value k−1 were the closest.

The target brightness of the internal signal value, image data used for evaluation, color display device and its adjustment, and measurement of the brightness and chromaticity are the same as those in the Example 1.

The results of measuring the brightness with respect to the internal signal value were almost the same as those in Example 1.

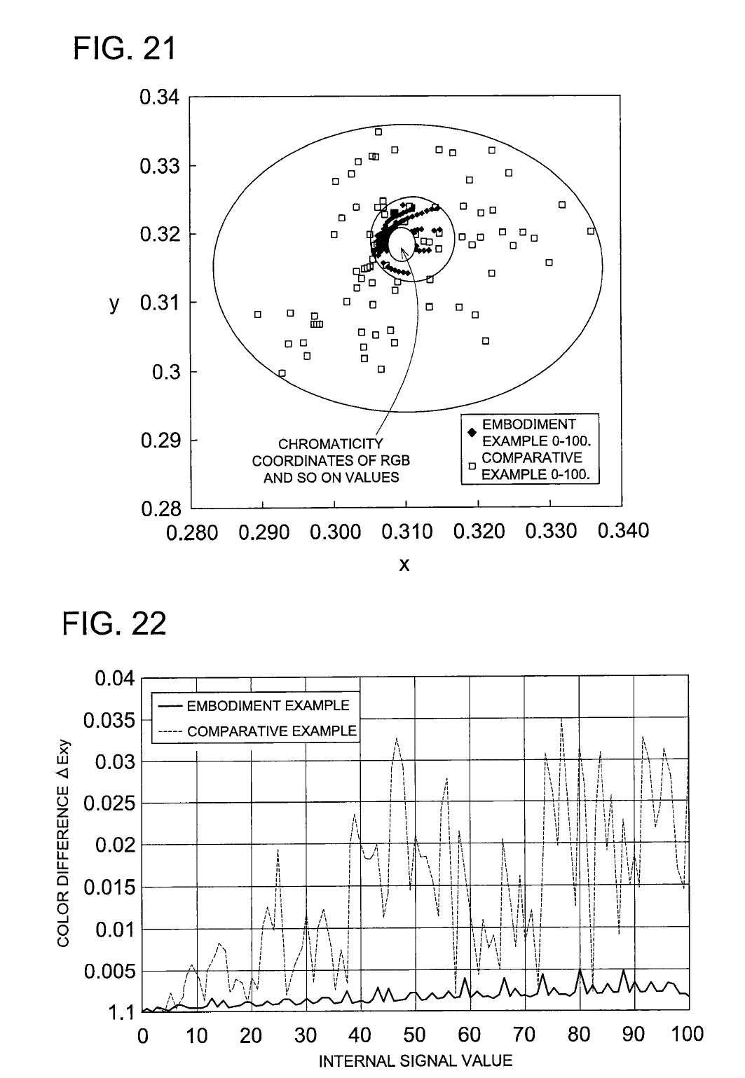

FIG. 21 shows the results of measuring the chromaticity. FIG. 21 is a CIE xy chromaticity chart. The chromaticity with respect to the internal signal values from 0 through 100 exhibits distribution over an extensive range in the Comparative Example. In this Example, however, the chromaticity is located close to the chromaticity of R, G, and B equivalent values and others. This suggests that the chromaticity is located in the adequate range.

In FIG. 22, the internal signal value is plotted on the horizontal axis, and the color difference between the adjacent internal signal values is plotted on the vertical axis. In the Example 2, the color difference between the adjacent internal signal values was still smaller than that of Example 1. The dispersion of chromaticity was not noticeable at all in the image exhibiting a smoother change in brightness.

As described above, in the present invention, a process of selection is carried out to select the candidate R, G, and B display image data in advance. This ensures a monochromatic image of adequate color tone to be displayed when the signal determination process is performed according to the simple algorithm using only the brightness information. Further, this permits multicontrast representation of two or more bits (four times) greater than the number of the display drive gradations, without having to perform the FRC display or the like.

Further, two-stage selection is performed in the signal determination process using color information, thereby ensuring a monochromatic image of further adequate color tone to be displayed.

1.-12. (canceled)

13. An image processing method wherein one-channel monochromatic image data of n+m bits (wherein “n” is a positive integer of 8 or more, and “m” is a positive integer of 2 or more) is converted into an n-bit 3 or more channel color display image data group, based on a predetermined association principle; the image processing method comprising:
acquiring display characteristics of a color display device by measuring a test pattern made up of a combination of color display data displayed on the color display device;
selecting a plurality of candidate color display image data having different signal values for each of signal values of the monochromatic image data;
acquiring target information, in which at least one of target brightness information and target chromaticity information corresponding to each of the monochromatic image data is acquired;
calculating at least one of brightness and chromaticity, based on the display characteristic acquired in the step of acquiring display characteristics, for each of the candidate color display image data;
determining signal values of color display image data corresponding to each of the signal values of the monochromatic image data, from the candidate color display image data selected in the step of selecting the plurality of candidate color display image data, based on at least one of a comparison between the brightness of each of the candidate color display image data calculated in the step of selecting the plurality of candidate color display image data and the target brightness, and a comparison between the chromaticity of each of the candidate color display image data calculated in the step of selecting the plurality of candidate color display image data and the target chromaticity; and
an association setting process for setting an association of the signal value of the monochromatic image data determined in the signal value determining process and the signal value of the color display image data.

14. The image processing method described in claim 13 wherein:
the acquiring target information comprises calculating the target brightness information and the target chromaticity information;
the calculating at least one of brightness and chromaticity calculates comprises calculating brightness and chromaticity; and
the determining signal values of color display image data comprises determining the signal values of the color display image data corresponding to each of the signal values of the monochromatic image data, based on the comparison between the brightness and target brightness, and the comparison between the chromaticity and target chromaticity.

15. The image processing method described in claim 14 wherein the signal determining process comprises:
selecting a plurality of primary candidate color display image data, based on the comparison between the brightness of each of primary candidate color display image data and the target brightness; and
selecting color display image data, based on the comparison between the chromaticity of each of the primary candidate color display image data and the target chromaticity.

16. The image processing method described in claim 13, wherein the selecting a plurality of candidate color display image data comprising selects color display image data in quantity of C·2̂n (2̂(m+1)≦C≦2̂(m+4)) as the candidate color display image data from among all the combinations of the color display image data that can be displayed.

17. The image processing method described in claim 13, wherein the image processing method comprises selecting a color tone for image display, and the test pattern displayed in the step of acquiring display characteristic is displayed based on color display image data selected from among combinations of previously stored color display image data, in response to the color tone selected in the step of selecting color tone.

18. The image processing method described in claim 13, wherein the color display image data of the test pattern is such a color display image data that CIE chromaticity coordinates (x, y) are located within a range enclosed by coordinates (0.2, 0.275), (0.275, 0.225), (0.325, 0.4), and (0.4, 0.35).

19. An image processing apparatus wherein one-channel monochromatic image data of n+m bits (wherein “n” is a positive integer of 8 or more, and “m” is a positive integer of 2 or more) is converted into an n-bit 3- or more-channel color display image data group, based on a predetermined association principle; the image processing apparatus comprises:
a display characteristic acquisition device for acquiring the display characteristics of the color display device by measuring a test pattern made up of a combination of the color display image data displayed on a color display device;
a candidate selection section for selecting a plurality of the candidate color display image data having different signal values for each of the signal values of the monochromatic image data;
a target information acquisition section for acquiring at least one of target brightness information and target chromaticity information corresponding to each of the monochromatic image data;
a brightness/chromaticity calculation section for calculating at least one of the brightness and chromaticity, based on the display characteristics acquired in the display characteristic acquisition section, for each of the candidate color display image data;
a signal value determination section for determining signal values of the color display image data corresponding to each of the signal values of the monochromatic image data, from the candidate color display image data selected in the candidate selection section, based on at least one of a comparison between the brightness of each of the candidate color display image data calculated in the brightness calculation section and the target brightness, and a comparison between the chromaticity of each of the candidate color display image data calculated in the chromaticity calculation section and the target chromaticity; and
an association setting section for setting an association of the signal value of the monochromatic image data and the signal value of the color display image data determined in the signal value determination section.

20. The image processing apparatus described in claim 19 wherein:
the target information acquisition section calculates the target brightness information and target chromaticity information;
the brightness/chromaticity calculation section calculates the brightness and chromaticity; and
the signal value determination section determines the signal values of the color display image data corresponding to each of the signal values of the monochromatic image data, based on the comparison between the brightness and the target brightness, and the comparison between the chromaticity and the target chromaticity.

21. The image processing apparatus described in claim 20 wherein the signal determination section comprises:
a brightness selection section for selecting a plurality of primary candidate color display image data, based on the comparison between the brightness of each of the candidate color display image data and the target brightness; and
a chromaticity selection section for selecting color display image data, based on the comparison between the chromaticity of each of the primary candidate color display image data and the target chromaticity.

22. The image processing apparatus described in claim 19, wherein the candidate selection section selects C·2̂n (2̂(m+1)≦C≦2̂(m+4)) as the candidate color display image data from among all the combinations of the color display image data that can be displayed.

23. The image processing apparatus described in claim 19 comprising:
a color tone selection section for selecting a color tone for image display; and
a test pattern holding section for storing a plurality of combinations of the color display image data test patterns;
wherein the display characteristic acquisition section selects a combination of the color display image data of the test patterns displayed on the display section, from among the combinations of the color display image data stored in the test pattern holding section, in response to the color tone selected by the color tone selection section.

24. The image processing apparatus described in claim 13, wherein the color display image data of the test pattern is such color display image data that CIE chromaticity coordinates (x, y) are located within the range enclosed by coordinates (0.2, 0.275), (0.275, 0.225), (0.325, 0.4), and (0.4, 0.35).
